(19) United States
(12) Patent Application Publication
(10) Pub. No.: US 2026/0009467 A1
(43) Pub. Date: Jan. 8, 2026

(54) METHOD AND CONTROL DEVICE FOR OPERATING A SHIFTING ELEMENT OF A MOTOR VEHICLE

(71) Applicant: ZF Friedrichshafen AG, Friedrichshafen (DE)

(72) Inventors: Andreas Graf, Stockach (DE); Marcel Störkle, Bad Saulgau (DE); Bernd Lutz, Uhldingen-Mühlhofen (DE)

(73) Assignee: ZF Friedrichshafen AG, Friedrichshafen (DE)

(21) Appl. No.: 19/261,060

(22) Filed: Jul. 7, 2025

(30) Foreign Application Priority Data
Jul. 8, 2024 (DE) 10 2024 206 397.5

(51) Int. Cl. F16H 61/68; F16D 23/14; F16H 63/32

(52) U.S. Cl. CPC F16H 61/68; F16D 23/14; F16H 63/32; F16D 2023/141

(57) ABSTRACT

A method is provided for operating a shifting element of a motor vehicle, where the shifting element has a shift sleeve which can be actuated from an actuator via a shift fork and which, in order to perform a gear shift via the shift fork, is actuated by the actuator in an actuation direction specified for the gear shift to be performed. The shift sleeve is displaced translationally from an actual position to a target position, after which the shift fork is actuated by the actuator in the direction opposite to the actuation direction specified for the gear shift to be performed, while maintaining the target position of the shift sleeve.

### RELATED APPLICATIONS

This application claims the benefit of and right of priority under 35 U.S.C. § 119 to German Patent Application no. 10 2024 206 397.5, filed on 8 Jul. 2024, the contents of which are incorporated herein by reference in its entirety.

### FIELD OF THE DISCLOSURE

The invention relates to a method for operating a shifting element of a motor vehicle. Furthermore, the invention relates to a control device for carrying out the method.

### BACKGROUND

DE 10 2018 207 590 A1 discloses a shifting element for a motor vehicle. The shifting element has a shift sleeve that can be actuated from an actuator via a shift fork. The actuator displaces the shift fork. which, depending on how it is actuated, displaces the shift sleeve via a shift fork head. This makes it possible to displace the shift sleeve translationally from an actual position to a target position by controlling the actuator.

After displacing the shift sleeve to its target position, the actuator is deactivated, i.e., no longer supplied with electrical current. This keeps the shift fork in the position at which the shift sleeve was displaced to the target position. This results in permanent contact between the shift fork, in particular a shift fork head thereof, and the shift sleeve, which can cause wear.

### SUMMARY

There is a need to operate a shifting element of a transmission, which has a shift sleeve that can be actuated by an actuator via a shift fork, with a reduced risk of wear. The purpose of the present invention is to provide a novel method and control device for operating a shifting element in a motor vehicle. This task is solved by a method and by a control device as disclosed herein.

According to the invention, after the shift sleeve has been displaced from its actual position to its target position, the shift fork is actuated by the actuator in the opposite direction to the actuation direction specified for the gear shift to be performed, while maintaining the target position of the shift sleeve.

The present invention proposes that, after the shift sleeve has been displaced into its target position, the shift fork is actuated by the actuator in the direction opposite to the actuation direction specified for the gear shift to be performed, while maintaining the target position of the shift sleeve. After the shift sleeve has been displaced into the target position, the shift fork is displaced slightly in the direction opposite to the actuation direction in order to maintain the target position of the shift sleeve and to prevent permanent contact and thus permanent axial movement of the shift sleeve. This reduces the risk of wear.

Preferably, after the shift sleeve has been displaced from its actual position to its target position, the shift fork is actuated by the actuator in the direction opposite to the actuation direction specified for the gear shift to be performed, in such a way that that, as a result of the actuation opposite to the actuation direction specified for the gear shift to be performed, there is no contact between the shift fork and the shift sleeve. This is particularly preferable in order to reduce the risk of wear.

Preferably, the shift fork engages in a groove in the shift sleeve and then, when the shift sleeve is displaced from its actual position to its target position, it rests against a wall of the groove. After the shift sleeve has been displaced from its actual position to its target position, the shift fork is actuated by the actuator in the direction opposite to the actuation direction specified for the gear shift to be performed, preferably in such a way that the shift fork does not subsequently come into contact with any wall of the groove. In particular, the shift fork is actuated via the actuator by half the groove width of the shift sleeve or by approximately half the groove width opposite to the actuation direction specified for the gear shift to be performed. This also helps to reduce the risk of wear.

### BRIEF DESCRIPTION OF THE DRAWINGS

Preferred further embodiments result from the subclaims and the following description. Exemplary embodiments of the implementation of the invention are explained in more detail, without being limited to these, by means of the drawing. It shows:

FIG. 1: is a highly schematic representation of a shifting element of a motor vehicle to be actuated according to the invention.

### DETAILED DESCRIPTION

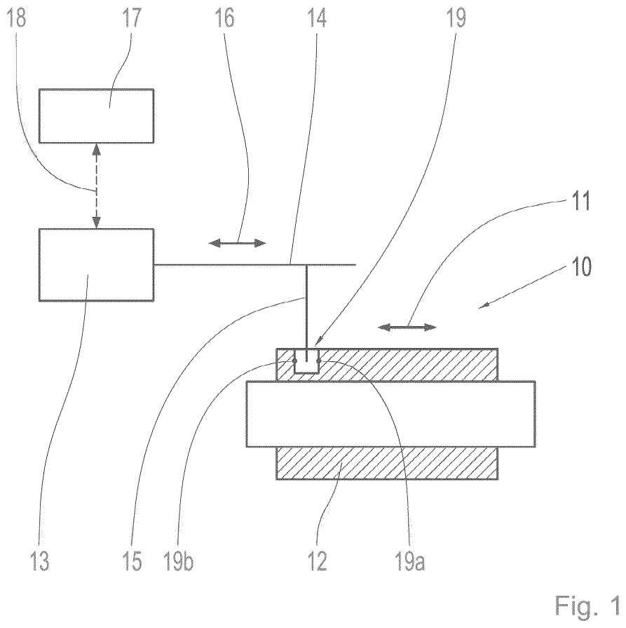

FIG. 1 shows a highly schematic representation of a shifting element 10 of a motor vehicle, in particular of a transmission, wherein the shifting element 10 has a shift sleeve 12 that can be displaced translationally in the direction of the double arrow 11. An actuator 13 is used to displace the shift sleeve 12. It displaces the shift sleeve 11 via a shift rod 14 and a shift fork 15. Actuator 13 may be an electric motor whose rotary motion is converted into a translational motion of the shift rod 14 and shift fork 15. The translational movement of the shift rod 14 and the shift fork 15 is shown by a double arrow 16.

A control device 17 is used to control actuator 13, which exchanges data with actuator 13 in accordance with the dashed double arrow 18

If the shift sleeve 12 is to be displaced from an actual position to a target position in order to perform a gear shift, the actuator 13 is energized from the control device 17 in order to actuate the shift fork 15 in an actuation direction specified for the gear shift to be performed and to displace the shift sleeve 12 to its target position in a defined manner via the shift fork 15.

According to the invention, it is provided that after the shift sleeve 12 has been displaced from the actual position to the target position, the shift fork 15 is actuated by the actuator 13 in the direction opposite to the actuation direction specified for the gear shift to be performed, while maintaining the target position of the shift sleeve 12. This is achieved in such a way that, as a result of the actuation in the direction opposite to the actuation direction specified for the gear shift to be performed, there is subsequently no longer any contact between the shift fork 15 and the shift sleeve 12, so that after the shift sleeve 12 has been displaced into the target position, there is no permanent contact between the shift fork 15 and the shift sleeve 12 and therefore no permanent axial movement of the shift fork 15 against the shift sleeve 12.

In the exemplary embodiment shown in FIG. 1, the shift sleeve 12 has a groove 19 into which the shift fork 15 protrudes with a section, wherein the section of the shift fork 15 protruding into the groove 19 is also referred to as the shift fork head. To displace the shift sleeve 12 from its actual position to the corresponding target position, the section of the shift fork 15 protruding into the groove 19 rests against a wall 19a or 19b of the groove 19. If the shift fork is to be displaced to the right in FIG. 1, shift fork 15 rests against wall 19a with the section protruding into groove 19. If, on the other hand, the shift sleeve 12 in FIG. 1 is to be displaced to the left, the section of the shift fork 15 protruding into the groove 19 rests against the wall 19b of the groove 19.

After the shift sleeve 12 has been displaced into its target position, the shift fork 15 is actuated by the actuator 13 in the direction opposite to the actuation direction specified for the gear shift to be performed, while maintaining the target position of the shift sleeve 12, namely in such a way that the shift fork 15 with its section protruding into the groove 19 does not subsequently come into contact with any of the walls 19a, 19b of the groove 19. In particular, the shift fork 15 is actuated via the actuator 13 by approximately half the groove width or by half the groove width of the groove 19 of the shift sleeve 12 in the direction opposite to the actuation direction specified for the gear shift to be performed, and is thus displaced so that the section of the shift fork 15 protruding into the groove 19 is then located approximately in the middle of the groove without coming into contact with the two walls 19a, 19b.

The invention also relates to a control device for a motor vehicle, which is designed to automatically carry out the above-described method on the control side.

The control device 10 therefore controls the actuator 13 to perform a gear shift by supplying electrical current to it in such a way that, to perform a gear shift, the shift fork 15 is actuated in an actuation direction specified for the gear shift to be performed. In this case, the shift sleeve 12 is displaced translationally from its actual position to the respective target position of the gear shift to be performed.

According to the invention, after the shift sleeve 12 has been displaced from the actual position to the target position for the gear shift to be performed, the control device 17 controls the actuator 13 in such a way that the shift fork 15 is actuated via the actuator 13 in the direction opposite to the actuation direction specified for the gear shift to be performed, while maintaining the target position of the shift sleeve 12 so that there is subsequently no permanent contact between the shift sleeve 12 and the shift fork 15.

The control device 17 according to the invention is preferably an electronic control device which has hardware and software means for carrying out the method according to the invention. The hardware resources include data interfaces for exchanging data with the assemblies involved in carrying out the method according to the invention, for example with the actuator 13. Furthermore, the hardware resources include data interfaces for exchanging data with the assemblies involved in carrying out the method according to the invention. The hardware resources also include a processor for data processing and a memory for data storage. Software-side means include program modules implemented in the control device for carrying out the method according to the invention.

### REFERENCE NUMBERS

10 shifting element
11 displacing the shift sleeve
12 shift sleeve
13 actuator
14 shift rod
15 shift fork
16 displacing the shift rod, shift fork
17 control device
18 data exchange
19 groove
19a wall
19b wall

1. A method for operating a shifting element (10) of a motor vehicle, the method comprising:
providing a shifting element (10) having a shift sleeve (12) which can be actuated from an actuator (13) via a shift fork (15);
displacing the shift sleeve (12) translationally from an actual position to a target position by the shift fork (15);
actuating the shift fork (15), by the actuator (13), in an actuation direction specified for the gear shift to be performed, in order to perform a gear shift;
after the shift sleeve (12) has been displaced from the actual position to the target position, actuating the shift fork (15) by the actuator (13) in a direction opposite to the actuation direction specified for the gear shift to be performed, while maintaining the target position of the shift sleeve (12).

2. The method according to claim 1, comprising:
after the shift sleeve (12) has been displaced from its actual position to its target position, actuating the shift fork (15) by the actuator (13) in the direction opposite to the actuation direction specified for the gear shift to be performed, in such a way that as a result of the actuation opposite to the actuation direction specified for the gear shift to be performed, there is no contact between the shift fork (15) and the shift sleeve (12).

3. The method according to claim 1, comprising:
engaging the shift fork (15) in a groove (19) in the shift sleeve (12);
resting the shift fork against a wall (19a, 19b) of the groove (19) when the shift sleeve (12) is displaced from the actual position to the target position; and
after the shift sleeve (12) has been displaced from the actual position to the target position, actuating the shift fork (15) via the actuator (13) in the direction opposite to the actuation direction specified for the gear shift to be performed, in such a way that the shift fork (15) does not come into contact with any wall (19a, 19b) of the groove (19).

4. The method according to claim 3, comprising:
after the shift sleeve (12) has been displaced from the actual position to the target position, actuating the shift fork (15) by the actuator (13) by approximately half of a width of the groove (19) in the shift sleeve (12) in the direction opposite to the actuation direction specified for the gear shift to be performed.

5. A control device (17) for operating a shifting element (10) of a motor vehicle, the control device (17) is configured to:
shift a gear via an actuator;
control the actuator (13) of the shifting element (10) in such a way that a shift sleeve (12) of the shifting element (10) is displaced translationally from an actual position to a target position via a shift fork (15) of the shifting element (10), which is actuated by the actuator (17) in an actuation direction specified for the gear shift to be performed;
after the shift sleeve (12) has been displaced from the actual position to the target position, control the actuator (13) in such a way that the shift fork (15) is actuated via the actuator (13) in a direction opposite to the actuation direction specified for the gear shift to be performed, while maintaining the target position of the shift sleeve (12).

6. The control device according to claim 5, wherein the control device is configured to automatically carry out the following method:
displacing, by the shift fork (15), the shift sleeve (12) translationally from the actual position to the target position;
actuating by the actuator (13), the shift fork (15) in the actuation direction specified, thereby performing the gear shift; and
after the shift sleeve (12) has been displaced from the actual position to the target position, actuating the shift fork (15) by the actuator (13) in the direction opposite to the actuation direction specified for the gear shift to be performed, while maintaining the target position of the shift sleeve (12).
